(19) United States
(12) Patent Application Publication
(10) Pub. No.: US 2011/0248833 A1
(43) Pub. Date: Oct. 13, 2011

(54) RFID SYSTEM

(75) Inventor: Matti Ritamäki, Nokia (FI)

(73) Assignee: Confidex Oy, Tampere (FI)

(21) Appl. No.: 13/082,590

(22) Filed: Apr. 8, 2011

Related U.S. Application Data
(60) Provisional application No. 61/322,028, filed on Apr. 8, 2010.

(51) Int. Cl. G06K 7/01

(52) U.S. Cl. 340/10.33

(57) ABSTRACT

An RFID system comprising: an RFID tag, an exciter, and an RFID reader. The RFID tag is an active RFID tag operating at an UHF band and being connected to an energy source for energizing the RFID tag, the RFID tag further comprising at least one tag antenna for wireless communication at an UHF band with the RFID reader, wherein the RFID tag is configured to have a semi-passive state and a ready state, the semi-passive state being arranged to change into the ready state by an UHF (Ultra High Frequency) wake-up signal received by the tag antenna, and said RFID reader comprising at least one antenna for wireless communication with the tag antenna, the exciter being arranged to generate and send the UHF wake up signal for changing the RFID tag from the semi-passive state to the ready state, and the RFID reader sending and/or receiving data with the RFID tag in the ready state.

### FIELD OF THE INVENTION

The present invention relates to an RFID system, an RFID tag and an RFID reader.

### BACKGROUND OF THE INVENTION

The present invention relates generally to the field of Radio Frequency Identification (RFID) systems, and more particularly to RFID systems which employ battery supported RFID transponders, i.e. active RFID tags, allowing a higher degree of active behavior in tags.

Active RFID tags communicating in UHF frequency range uses significant amount of battery energy, when the tag is receiving an RF signal from the reader or other tags. The tag can consume, for instance, 10-20 mA current when its receiver is switched on.

In order to extend battery life the active tags may usually be switched to a sleep mode where their energy consumption is minimized. Such tags are in the sleep mode most of time but they wake up periodically to listen the readers, i.e. interrogators. The tag may be configured to wake up for example once in minute or hour. This way the life time of the battery and the tag can be extended substantially.

The periodically occurring wake up causes problems in fast moving applications where the tag is passing the reader very quickly. To overcome this problem LF (low frequency) exciters are utilized to give required wake up signal for the tag. The wake up signal is an alert signal that activates the tag for communicating with the reader. Said LF systems operates typically at frequency of 125 kHz. LF band is traditionally used because low frequencies penetrates well through various object, which make it reliable in harsh conditions. LF is also common, because it has been used in different remote control and active transponder applications.

Simple LF receivers consumes current in range of few μA, which is significantly less than active UHF receiver. The exciters are placed to the reading points. An disadvantage of LF wake up is low data rate (around 1000 bps). Another disadvantage of LF wake up is that it requires an additional LF receiver arranged in the tag and expensive antenna coils.

### SUMMARY OF THE INVENTION

It is an object of the present invention to provide an RFID system, an RFID tag and an RFID exciter, by which the above problems will be reduced.

According to an aspect of the invention, the system comprises an RFID tag, an exciter, and an RFID reader, the RFID tag being an active RFID tag operating at an UHF band and being connected to an energy source for energizing the RFID tag, the RFID tag further comprising at least one tag antenna for wireless communication at an UHF band with the RFID reader, wherein the RFID tag is configured to have a semi-passive state and a ready state, the semi-passive state being arranged to change into the ready state by an UHF (Ultra High Frequency) wake-up signal received by the tag antenna, and said RFID reader comprising at least one antenna for wireless communication with the tag antenna, the exciter being arranged to generate and send the UHF wake up signal for changing the RFID tag from the semi-passive state to the ready state, and the RFID reader sending and/or receiving data with the RFID tag in the ready state.

According to an aspect of the invention, the RFID tag operates at a UHF band and is connected to a power source serving as a source of energy of the RFID tag and to at least one tag antenna for wireless communication, wherein the RFID tag comprises a semi-passive state and a ready state, the semi-passive state being arranged to change into the ready state by a UHF (Ultra High Frequency) wake-up signal received by the tag antenna.

According to an aspect of the invention, the RFID exciter comprises at least one antenna for wireless communication with an RFID tag, the exciter being arranged to generate and send a UHF wake up signal for changing the RFID tag from its semi-passive state to a ready state for communicating with an interrogator in said ready state.

The basic idea of the invention is that the wake up function is implemented through a wake up signal that operates at UHF frequency range, i.e. at the same range as the tag is construed to communicate with the reader in the ready state.

The invention has an advantage that the tag assisted with a commonly used battery consumes only few μA current in the semi-passive state and, thus, the lifetime of the tag may be extended substantially.

Another advantage of the invention is that vast exciter networks are not required to be created because already available readers used for reading passive UHF tags may be exploited as exciters of the tags of the invention.

Further advantage of the invention is that tags of the invention may act as a BAP (Battery Assiste Passive) tags, i.e. they may communicate in passive mode also. Thanks to this the tag of the invention can be identified with passive reader even if the battery is empty.

Still further advantage of the invention is that BAP UHF wake up can operate up 50 meters and ISO 18000-6 standard data rate can be up to 640 kbps, which enables very fast wake up. Wake up signal can be simple Query command or custom command. It is to be noted here that ISO 18000-6 standard encompasses in this description standards ISO 18000-6A, ISO 18000-6B and ISO 18000-6C, for instance. It is to be noted, however, that the invention may also be suitable for applying in other RFID standards and protocols not specifically mentioned here. Therefore, all the numerical values shown in the Figures, such as minimum and maximum values of times or periods or frequencies of signals, as well as shapes and structures of the signals or structures of the communication are shown just as examples of embodiments of such features.

The basic idea of an embodiment of the system, tag and exciter in accordance with the invention is that the UHF wake up signal operates at the same UHF band than the active tag itself. The band may be, for instance, 433 MHz or 915 MHz.

The basic idea of an embodiment of the system, tag and exciter in accordance with the invention is that the UHF wake up signal operates at a different UHF band compared to the tag itself. For example the UHF wake up signal may operate at 433 MHz and the tag at 915 MHz, or vice versa.

The basic idea of an embodiment of the system, tag and reader in accordance with the invention is that the wake up signal is carried out according to a standard ISO 18000-6C protocol. This kind of wake up signal, for instance, may wake up ISO 18000-7 standard active tag when the tag passes RFID portal having capacity to read passive tags. It is to be noted here that the RFID system, the RFID tag and the RFID exciter of the invention may fulfill requirements of such RFID standards or RFID protocols which are not mentioned in this description.

The tag which the wake up signal has activated may continue communication with the reader and, for instance, lot of sensor logging data can be transferred to the active tag reader. The active state of the tag may be ended by a command sent to the tag or after a specific period of time has lapsed after a received data.

The basic idea of an embodiment of the system and tag in accordance with the invention is that the tag is configured to use same antenna in active and semi-passive mode. The very same antenna may be used for communication in the active mode and for receiving the wake up signal. The antenna may be so called dual frequency antenna.

The basic idea of an embodiment of the system and tag in accordance with the invention is that the tag is configured to use a first antenna for communication in the active mode and a second antenna for receiving the wake up signal.

### BRIEF DESCRIPTION OF THE DRAWINGS

Some embodiments of the invention are described in greater detail in connection with the attached drawings, in which

FIG. 1 is a flow chart of a function of a commonly known tag;

FIG. 2 is a schematic view of a commonly known wake-up signal;

FIG. 3 is a schematic view of commonly known communication between a tag and an interrogator;

FIG. 4 is a schematic view of a system in accordance with the invention;

FIG. 5 is a schematic view of a tag in accordance with the invention;

FIG. 6 is a schematic view of a second tag in accordance with the invention; and

FIG. 7 is a schematic view of a third tag in accordance with the invention.

For the sake of clarity, the invention is shown in a simplified manner in the figures.

### DETAILED DESCRIPTION OF THE INVENTION

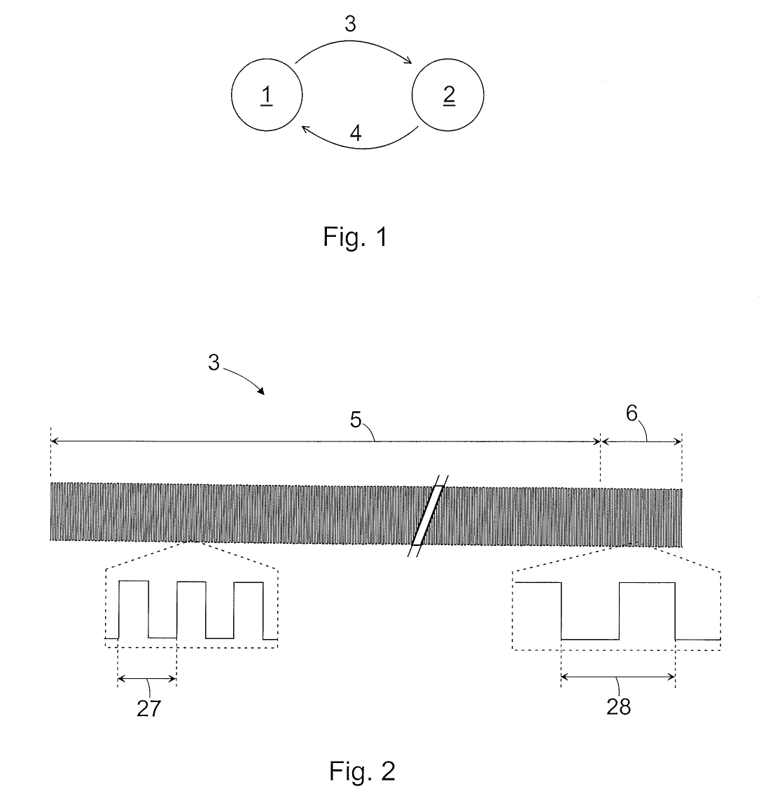

FIG. 1 is a flow chart of a function of a commonly known tag. According to ISO18000-7 standard, the tag has two states, i.e. a sleep state 1 and a ready state 2. When the tag is in its sleep state, it will consume minimum amount of energy. RF transceiver and CPU is usually turned off in the sleep state. The longer time the tag is in the sleep state the longer is the battery life time. The tag will ignore all commands from the reader in the sleep state.

Another ISO18000-7 state is called ready state 2. The tag will go to the ready state when it has successfully received a wake-up signal 3 (a wake-up signal is shown in FIG. 2). The tag can receive all commands from the reader when it is in the ready state 2. Energy consumption is higher in the ready state, since CPU and other peripherals, if any, are on. The tag will go back 4 to the sleep state when a certain time, for instance 30 second, has gone from the last successfully received command.

FIG. 2 is a schematic view of a commonly known wake-up signal 3 according to ISO18000-7 standard. The wake-up signal 3 is transmitted by the reader. The wake-up signal 3 changes the mode of tag from a sleep mode or state to a ready mode or state.

Wake-up signal 3 starts with the wake-up header 5. Period 27 of the header 5 is 32 μs. Duration of the header 5 is from 2.35 s to 4.8 s. The header 5 is followed by 0.1 s co-header 6, which period 28 is 100 μs. It is to be noted that the durations and periods may also differ from those described here if ISO18000-7 standard is not followed.

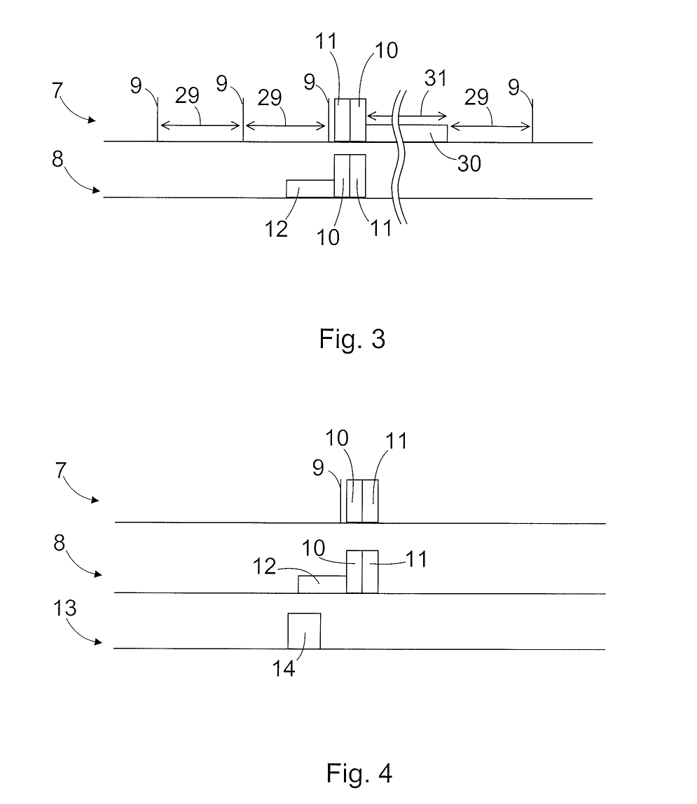

FIG. 3 is a schematic view of commonly known communication between a tag 7 and an interrogator 8. The tag 7 has to listen the wake-up signal at least every 2.45 s at wakeup detects 9. The listening requires turning on the radio receiver arranged in the tag 7, which consumes remarkable amount of energy. A listening period 29 is determined by the duration of the wake-up command. After a successful wake-up command 12 is received, normal TX-RX communication, marked by reference numbers 10, 11, respectively, may be started according the ISO18000-7 standard. After the communication there is a waiting period 30, the length 31 of which may be, for instance, 30 s, after which starts a listening period 29. FIG. 4 is a schematic view of a system in accordance with the invention, i.e. communication with an UHF wake-up function. An UHF exciter 13 can reduce the energy consumption significantly, since the tag 7 needs to listen wake-up command 12 only after it has received UHF wake-up signal 14 (TX+RX). UHF exciter signal detection will consume significantly less energy, since it is based on similar technology than what is used in passive and semi-passive RFID tags. UHF exciter 13 enables also faster wake up time, which is required for fast moving objects.

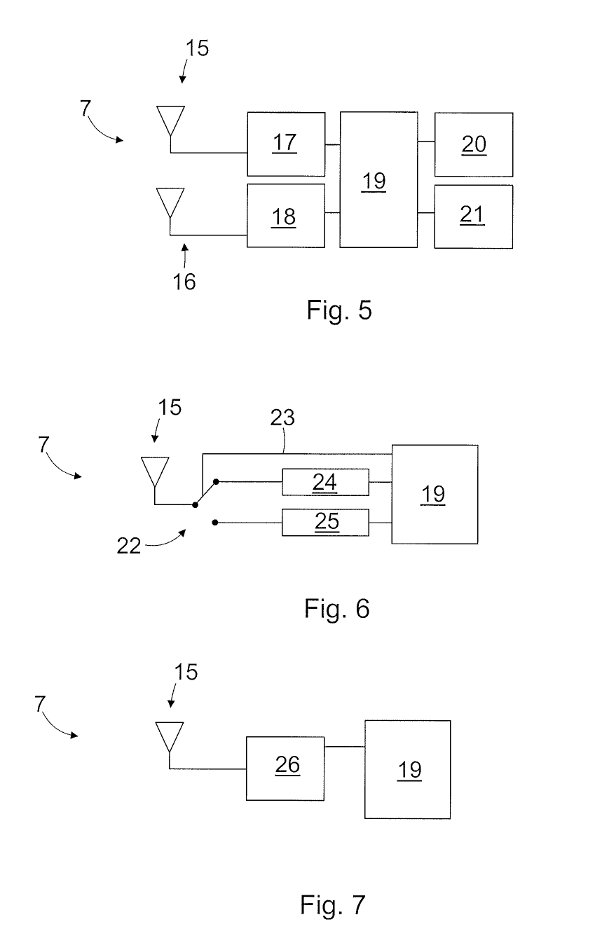

FIG. 5 is a schematic view of a tag in accordance with the invention. Means and methods for UHF wake-up signal detection can be implemented many ways. The tag 7 can have two separate antennas 15, 16, which are operating different frequency bands.

First antenna 15 is connected to an RF transceiver 17 which is capable to communicate according to ISO18000-7 standard, e.g. at frequency 433 MHz or 869/915 MHz. It is to be noted that it is not compulsory to follow ISO18000-7 standard but the invention may also be carried out following some other standardized or not standardized principle.

Second antenna 16 is connected to an UHF detector 18, which can also communicate to a reader with back-scatter method. Two way communication is not required.

The microprocessor or microcontroller 19 may control all peripherals 20, which can include various sensors like temperature, humidity and shock. Also displays, LEDs and keyboards can be connected to the microcontroller. Energy for the device is coming from a battery or some other power source 21. The battery 21 may be charged with electricity generated by means known as such, like by means of solar panels or kinetic energy.

FIG. 6 is a schematic view of a second tag in accordance with the invention. An UHF exciter functionality can be also implemented with using a first antenna 15 only. The first antenna 15 may be multiband antenna if an UHF exciter is operating different frequency than actual transceiver. Also wideband antennas can be used. Principle of tag operation is same than in FIG. 5 except there is an RF switch 22 between UHF detector (for example ISO18000-6) and transceiver. The switch is controlled by a switch controller signal 23 of the microcontroller 19. An UHF detector, i.e. an UHF BAP interface 24, is switched to the first antenna 15 during sleep mode. When a signal from UHF exciter is detected, the ISO18000-7 transceiver, i.e. an active tag interface 25 is switched to the antenna 15.

FIG. 7 is a schematic view of a third tag in accordance with the invention. An UHF exciter signal detector and RF transceiver can be also integrated 26 on one chip. In that case switch functionality is implemented internally to the chip and an external switch is not needed.

It will be obvious to a person skilled in the art that, as the technology advances, the inventive concept can be implemented in various ways. The invention and its embodiments are not limited to the examples and Figures described above but may vary within the scope of the claims.

### REFERENCE SYMBOLS

1 sleep state
2 ready state
3 wake-up signal
4 go back
5 wake-up header
6 co-header
7 tag
8 interrogator
9 wake-up detect

### 10 TX

### 11 RX

12 wake-up command

### 13 UHF-exciter

14 UHF wake-up signal
15 first antenna
16 second antenna
17 RF transceiver
18 UHF detector
19 microcontroller 19
20 peripherals
21 power source
22 RF switch
23 switch controller signal
24 UHF BAP interface
25 active tag interface
26 integrated UHF BAP and active tag interfaces
27 period of the header
28 period of co-header
29 listening period
30 waiting period 30
31 length 31 of waiting period

1. An RFID system comprising:
an RFID tag, an exciter, and an RFID reader,
the RFID tag being an active RFID tag operating at an UHF band and being connected to an energy source for energizing the RFID tag, the RFID tag further comprising
at least one tag antenna for wireless communication at an UHF band with the RFID reader, wherein
the RFID tag is configured to have a semi-passive state and a ready state,
the semi-passive state being arranged to change into the ready state by an UHF (Ultra High Frequency) wake-up signal received by the tag antenna, and said RFID reader comprising at least one antenna for wireless communication with the tag antenna,
the exciter adapted to generate and send the UHF wake up signal for changing the RFID tag from the semi-passive state to the ready state, and
the RFID reader sending and/or receiving data with the RFID tag in the ready state.

2. The system of claim 1, wherein the UHF wake up signal is at the same UHF band as the wireless communication between the RFID tag and the RFID reader.

3. The system of claim 1, wherein the UHF wake up signal is at a different UHF band compared to the wireless communication between the RFID tag and the RFID reader.

4. An RFID tag operating at an UHF band and connected to a power source serving as a source of energy of the RFID tag and to at least one tag antenna for wireless communication, wherein the RFID tag comprises a semi-passive state and a ready state, the semi-passive state changing into the ready state by an UHF (Ultra High Frequency) wake-up signal received by the tag antenna.

5. The tag of claim 4, comprising one antenna and a switch for changing connection of the antenna from a UHF detector to an RF transceiver.

6. The tag of claim 4, comprising one antenna and a chip comprising an UHF exciter signal detector and an RF transceiver.

7. The tag of claim 4, comprising two antennas, a first antenna being connected to an RF transceiver and a second antenna being connected to an UHF detector.

8. The tag of claim 4, wherein the power source is a battery.

9. The tag of claim 4, wherein the power source is a solar cell.

10. The tag of claim 4, wherein the power source is a device configured to convert kinetic energy into electric energy.

11. An RFID exciter, comprising at least one antenna for wireless communication with an RFID tag, the exciter being arranged to generate and send an UHF wake up signal for changing the RFID tag from its semi-passive state to a ready state.

12. The RFID exciter of claim 11, wherein the UHF wake up signal is arranged to the same UHF band as the wireless communication between the RFID tag and an RFID reader configured to communicate with the RFID tag.

13. The RFID exciter of claim 11, wherein the UHF wake up signal is arranged to a different UHF band compared to the wireless communication between the RFID tag and an RFID reader configured to communicate with the RFID tag.

14. The RFID exciter of claim 11 being separated from an RFID reader configured to communicate with the RFID tag.

15. The RFID exciter of claim 11 being integrated with an RFID reader configured to communicate with the RFID tag.
